(19) United States
(12) Patent Application Publication
(10) Pub. No.: US 2010/0052535 A1
(43) Pub. Date: Mar. 4, 2010

(54) MINIATURE LIGHT BULB FOR RANDOM HIGH-LOW TWINKLE IN A SERIES-WIRED LIGHT STRING

(76) Inventor: John L. Janning, Bellbrook, OH (US)

Correspondence Address: DICKSTEIN SHAPIRO LLP, 1825 EYE STREET NW, Washington, DC, 20006-5403, US

(21) Appl. No.: 12/616,098

(22) Filed: Nov. 10, 2009

Related U.S. Application Data
(63) Continuation-in-part of application No. 12/247,975, filed on Oct. 8, 2008.
Application No. 12/247,975 is a continuation-in-part of application No. 12/029,329, filed on Feb. 11, 2008.
Application No. 12/029,329 is a continuation-in-part of application No. 11/542,184, filed on Oct. 4, 2006, now Pat. No. 7,342,327.

(51) Int. Cl. H01K 1/64

(52) U.S. Cl. 315/72

(57) ABSTRACT

A flasher bulb including a thermal shorting element that alternately shorts and opens only a portion of the bulb filament, thus causing the flasher bulb to produce an alternating high-low illumination. The thermal element is activated by current passing through the element, rather than by heat from the filament. The amount of brightness differential between the “high” and “low” illumination of the flasher bulb is determined by the amount of bulb filament that is shorted out when the thermal element inside the bulb is in the closed position. When a plurality of such flasher bulbs are placed in the sockets of a series-wired light string, they cause the light string to exhibit a random high-low twinkle.

### CROSS-REFERENCE TO RELATED APPLICATIONS

This application is a continuation-in-part of application Ser. No. 12/247,975, filed Oct. 8, 2008, which is a continuation-in-part of application Ser. No. 12/029,329, filed Feb. 11, 2008, which is a continuation-in-part of application Ser. No. 11/542,184, filed Oct. 4, 2006, now U.S. Pat. No. 7,342,327, all of which are incorporated herein by reference.

### BACKGROUND OF THE INVENTION

One of the most common uses of light strings is for decoration and display purposes, particularly during Christmas and other holidays, and more particularly for the decoration of Christmas trees, and the like. Probably the most popular light set currently available on the market, and in widespread use, comprises one or more strings of fifty miniature light bulbs each, with each bulb typically having an operating voltage rating of 2.5 volts, and whose filaments are connected in an electrical series circuit arrangement.

Often, in holiday lighting, flasher bulbs are incorporated in the series-wired string of lights in order for the entire light string to go off and on. Recently, Christmas light strings have become available with miniature light bulbs that flash off and on individually without the entire light string flashing off and on. The parent patents of the present application, upon which priority is claimed, teach such a circuit, which is shown in FIG. 1. A microchip or other voltage responsive shunt 22-31 in the sockets of the flasher bulbs 12-21 continues the current through the series-wired light string when the flasher bulb in the socket goes off and the circuit opens. The off-on action of the flasher bulbs 12-21 is controlled by a bi-metallic switching element inside the bulb. Initially, current flows through the bi-metallic element en route to the bulb filament. In doing so, it warms and pulls away from a contact that connects it to the bulb filament, thus opening the circuit and extinguishing the bulb. Upon cooling, the bi-metallic switching element resumes contact and the bulb lights again. The cycle is repeated.

Random twinkling of Christmas lights is a desirable feature in decorative lighting, including the series-wired light strings with flashers described above. However, it would be desirable to provide random twinkling at various levels of illumination—i.e., high-low twinkling in a series-wired light string.

U.S. Pat. No. 2,235,360 to Davis, Jr. teaches a flasher lamp with dual series connected filaments, and with a thermal element permanently connected at one side to a lead to a first one of the filaments. As the thermal element is heated by the first filament, it moves into contact with a dummy lead wire connected to a point between the two filaments, thereby shorting out the first filament, and diminishing the light output by the bulb. As the first filament cools, the thermal element cools, whereby it moves back out of contact with the dummy lead wire, thereby allowing current to pass again through the first filament, and increasing the light output from the bulb. The problem with such a high-low twinkle flasher lamp is that it is normally in the brightest state, and if the thermal element fails, the lamp remains in the highest output state, which is dangerous. Also, the high-low twinkle flasher bulb of Davis, Jr. also relies upon radiant heat from the filament to activate and deactivate the thermal element, rather than providing a thermal element that is more reliably heated directly by current passing through the element.

The present invention overcomes the disadvantages noted above by providing a circuit for dual brightness twinkle in which the bulb is normally in the low brightness state, and which includes a thermal element that is activated by current passing through the thermal element to switch the bulb to a high brightness state.

### SUMMARY OF THE INVENTION

In accordance with the present invention, a new and novel flasher light bulb is provided that produces high-low random twinkle, whereby the flashing of the flasher bulb does not open or close the current passing through the filament of the flasher bulb, as in the prior patents, but instead causes only a portion of a bulb filament to short out and reopen as the thermal shorting element inside of the flasher bulb, activated by current passing through the element, shorts and opens. This action causes the illumination of the bulb to change from one illumination level to another—producing a high-low random twinkle effect.

The amount of brightness differential between the “high” and “low” illumination of the flasher bulb is determined by the amount of bulb filament that is shorted out when the thermal element inside the bulb is in the closed position. In the preferred embodiment of the invention, for example, 50 percent of the bulb filament is shorted out when the thermal element closes. To produce an effect in which the flasher bulb twinkles brighter than the other bulbs in the light string, the flasher bulb filament can be formed as a double filament, so that the portion of the filament that still passes current and produces illumination upon closure of the thermal element is nearly the same as the filament of the other light bulbs in the string, and when the thermal element opens, the illuminated filament is equivalent to a double filament, producing twice the light of other standard bulbs in the string.

Advantageously, since the high-low flasher light bulb of the present invention never turns off completely, it can incorporate internal shunt wiring as described in parent application Ser. No. 12/029,329, filed Feb. 11, 2008, the disclosure of which is incorporated by reference, to keep the string operating in the event of a failure of the flasher bulb.

Also advantageously, since the high-low light bulb of the present invention is normally in the minimum brightness state and as the bi-metallic switching element is activated, the brightness increases to its maximum state. Thus, if a bulb fails to flash, it is not a problem, as the bulb remains in the safe, low brightness state.

Other features and advantages of the present invention will become apparent when the following description is read in conjunction with the accompanying drawings.

### BRIEF DESCRIPTION OF THE DRAWINGS

FIG. 1 is an electrical schematic diagram of a series-wired light string employing a conventional flasher bulb;

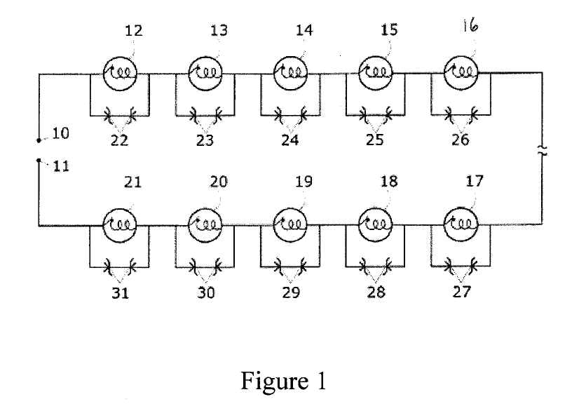

FIG. 2 is electrical schematic diagram of a first embodiment of the flasher bulb of the present invention; and

FIG. 3 is an electrical schematic diagram of a second embodiment of the flasher bulb of the present invention.

### DESCRIPTION OF THE PREFERRED EMBODIMENT

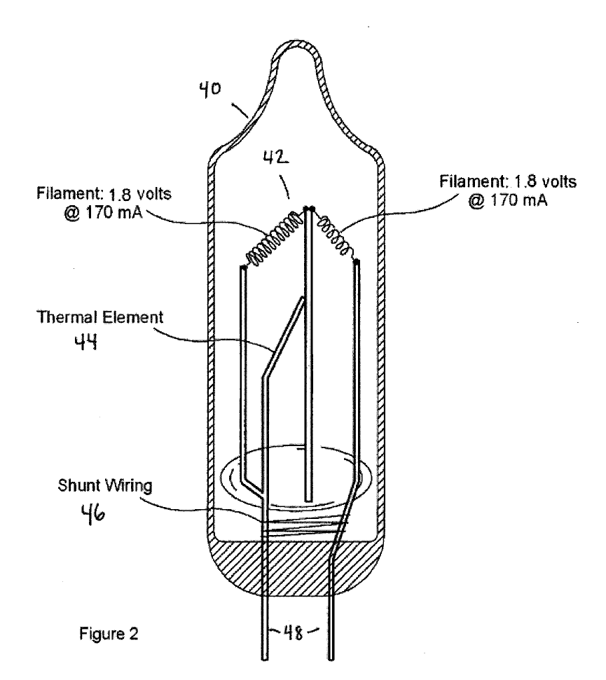

With reference to the schematic diagram in FIG. 2, the novel high-low flasher light bulb 40 of the present invention is provided with a filament 42 that is only partly shorted out as the thermal element 44 closes. Thus, the flashing of the flasher bulb 40 does not open or close the circuit in a series-wired light string, as in the prior art, but instead causes only a portion of a bulb filament to alternately short out as the thermal shorting element inside of the flasher bulb shorts part of the lamp filament. This action causes the illumination of the bulb to change from one illumination level to another—as a high-low random twinkle.

The operation of the present invention is simple. The normal operation of a flasher bulb is to provide current to the filament of a miniature light bulb through a thermal element in contact with a filament lead wire. As the current flows through this thermal element, it begins to heat. This heating causes the thermal element to pull away from the filament lead wire, thus, opening the electrical circuit. Since current no longer flows through the thermal element, it cools and returns to contact the filament wire once again causing the flasher bulb to illuminate again and the thermal element to begin warming again. Thus, the cycle is repeated.

In the high-low random twinkle bulb 40 of the present invention, shown in FIG. 2, the operation is similar except only a portion of the filament 42 is shorted out by the periodic closure of the thermal element 44. Therefore, it can be seen that the bulb 40 is never fully extinguished, even when the thermal element 44 opens.

Since the current in a series-wired light string is the same throughout the string, when approximately half of the filament is shorted out in a high-low bulb of the present invention, there is little change in the illumination of the remaining bulbs in the string. Placing several of the flasher bulbs of the present invention in a light string will provide for a pleasing high-low random twinkle without affecting the remaining bulbs in the string. For example, if a 50 light string contained four of such flasher bulbs, the largest change in voltage across the remaining 46 bulbs would only be approximately one-tenth of a volt per bulb—and—that is only if all of the four flasher bulbs were shorted at the same time. Bulbs in a typical 50 light string are rated at 2.5 volts each. When a 50 light string is operated at 120 VAC, each bulb receives an average of 2.4 volts each.

The amount of brightness differential desired will determine how much of the bulb filament is shorted out. In a preferred embodiment, approximately 50 percent of the bulb filament is shorted out, but more of the filament may be shorted out for a greater brightness differential.

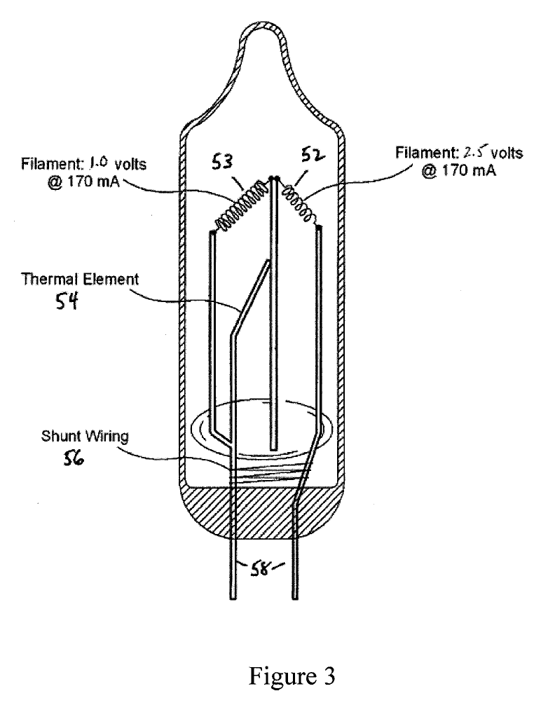

Another type of ‘twinkle’ using the method of the present invention of opening and closing of the thermal element of a flasher bulb is shown in FIG. 3 where the initially turned on filament 52 is the same as the filament in the other bulbs in a 50 bulb light string, i.e. operating at 2.5 volts with a current consumption of approximately 170 milliamperes. As the thermal element 54 opens, another filament 53 is added to the series-wired circuit. This configuration could be considered a two-filament flasher bulb or a “center tapped” filament inside the bulb. This type of operation could be called “Twinkle Bright” since the flasher bulb changes state from the same brightness of other bulbs to an increased brightness.

Advantageously, since the flasher bulb of the present invention never turns off completely, shunt wiring 46 and 56, as shown in FIGS. 2 and 3, can be incorporated in the flasher bulb to ensure continued operation of the light string in the event a flasher bulb fails.

The shunt wiring 46, 56 is a wire wrapped a few times around the two posts 48, 58 inside the bulb. The shunt wiring contains a coating that gives it a fairly high resistance until the flasher bulb filament burns out. If this occurs, the full line voltage appears across the leads of the flasher bulb (upon failure of a shunt located in a socket, if one exists) and hence across the shunt wiring. If that starts to happen, when the voltage rises up to 40 volts or so, the oxide coating on the shunt wiring breaks down and the shunt wiring gets welded to the bulb input terminals. This causes the shunt wiring to act as a shunt, shorting the flasher bulb and enabling continued operation of the light string.

In the case of the socket shunt operating correctly, if one exists, and the flasher filament intact, there is no current flowing through the shunt wiring, and it does not act as a shunt. Thus, in reality, there is no shunt internal to the flasher bulb until it connects by the oxide coated wire breaking down and causing the shunt wire to connect—which normally takes about 40 volts. The 40 volts could only appear across the shunt wiring in a set with shunts in the socket when such a shunt would fail. There could never be a situation where both shunts would be activated at the same time. The shunt wiring in the bulb acts as a shunt only if and when the shunt in the socket (if provided) fails and opens up.

Having so described and illustrated the principles of my invention in a preferred embodiment, it is intended, therefore, in the annexed claims, to cover all such changes and modifications as may fall within the scope and spirit of the following claims.

What is claimed is:

1. A series-wired light string, comprising: a plurality of light bulbs including a plurality of twinkle light bulbs; and a plurality of light sockets, each light socket of the plurality of light sockets adapted to receive at least one of the plurality of light bulbs; wherein the twinkle bulbs each includes two filaments connected electrically in series and a thermal element that moves alternately between an open position and a closed position as the thermal element heats and cools, wherein, the thermal element is initially in the closed position, causing one of the filaments to be shorted out, such that the other filament carries current and is illuminated, whereby this illuminated filament produces light of a first brightness, and wherein, when the thermal element moves to the open position, due to heat from current flowing through it, both filaments begin to carry current and are illuminated, whereby the combined filaments produce light of a second brightness higher than the first brightness, thereby causing the twinkle light bulbs in the series-wired light string to produce illumination of a high and low brightness at different times to cause the light string to exhibit a twinkling effect.

2. A series-wired light string as recited in claim 1, wherein the twinkle bulbs are provided with internal shunts.

3. A series-wired light string as recited in claim 1, where one of the filaments is shunted initially.
